(19) United States
(12) Patent Application Publication
(10) Pub. No.: US 2025/0073938 A1
(43) Pub. Date: Mar. 6, 2025

(54) SLICING MACHINE, IN PARTICULAR SLICER, AND METHOD

(71) Applicant: MULTIVAC SEPP HAGGENMÜLLER SE & CO. KG, Wolfertschwenden (DE)

(72) Inventors: Klaus BERNHARD, Dietmannsried (DE); Albert HARTMANN, Dietmannsried (DE)

(73) Assignee: MULTIVAC SEPP HAGGENMÜLLER SE & CO. KG, Wolfertschwenden (DE)

(21) Appl. No.: 18/825,340

(22) Filed: Sep. 5, 2024

(30) Foreign Application Priority Data
Sep. 5, 2023 (DE) 102023123878.7

(51) Int. Cl. B26D 1/18

(52) U.S. Cl. CPC B26D 1/185

(57) ABSTRACT

A slicing machine, in particular a slicer, for slicing at least one product caliber into slices and for producing portions from the slices, comprises a cutting unit with a blade for cutting slices from the at least one product caliber, a feed unit for feeding the at least one product caliber to the cutting unit along a feed direction, and a control unit. The slicing machine further comprises a measuring device which is in signal connection with the control unit and is adapted to measure at least one dimension of the at least one product caliber in a height direction of the at least one product caliber in order to determine a first cut length, in particular automatically.

### CROSS-REFERENCE TO RELATED APPLICATIONS

This application claims priority to German Patent Application No. DE 102023123878.7 filed on Sep. 5, 2023, the disclosure of which is incorporated in its entirety by reference herein.

### TECHNICAL FIELD

The invention relates to slicing machines, in particular so-called slicers, which are used in the food industry to slice strands of an only slightly compressible product such as sausage or cheese. The invention further relates to a method for slicing at least one product caliber, in particular by means of a slicing machine according to the invention.

### BACKGROUND

Since these strands can be produced with a cross-section that maintains its shape and dimensions well over their length, i.e. remains substantially constant, they are called product calibers.

In most cases, several product calibers arranged parallel to one another on individual tracks are cut side by side at the same time by cutting one slice at a time by the same blade, which moves in a transverse direction to the longitudinal direction of the product caliber.

The product calibers are moved forwards by a feed conveyor of a feed unit towards the blade of the cutting unit, usually on a downwardly inclined feed conveyor, and are guided in each case through the product openings of a plate-type so-called cutting frame, at whose front ends the part of the product caliber projecting beyond it is cut off as a slice by the blade immediately in front of the cutting frame.

During slicing, the product calibers are usually held at their rear end facing away from the cutting frame by a gripper which is equipped with corresponding gripper claws to prevent uncontrolled downward movement of the product calibers.

Before cutting a product caliber into slices, it is customary to make a so-called first cut at the end of the product caliber facing towards the cutting unit, i.e. to cut off an end piece of the product caliber, since the product calibers are usually tapered at their ends, which can reduce the dimensions of the product calibers in the end regions, at least in the height direction. Without making a first cut, therefore, at least some of the first slices cut from a product caliber would have a slice height that is too small, i.e., for example, in the case of a substantially circular product caliber, a slice diameter that is too small, so that at least these slices, including their corresponding packaging, would have to be sorted out as rejects.

With known slicing machines, a first cut length in the throughput direction for the product caliber in question is usually entered manually at a control unit of the slicing machine, so that the slicing machine can initially make the first cut, i.e. a thicker slice of the product caliber in the throughput direction, from the end of the product caliber facing towards the cutting unit.

Since, however, product calibers can have different shapes to one another and therefore different first cut lengths, the first cut length specified at the slicing machine is usually slightly greater in order to ensure that even a product caliber that requires a comparatively long first cut length is still cut in such a way that the slices subsequently sliced have the desired dimensions.

However, especially in the case of product calibers with a short first cut length, this means that an excessively large end piece of such product calibers is often sliced off as a first cut, leading to an unnecessarily large reduction in the possible number of slices per product caliber and ultimately to food wastage. Also, if the length of the first cut is too great, the slicing machine has to be loaded more frequently with new product calibers, which can ultimately increase the cycle time of the slicing machine and, in particular, of a downstream packaging machine.

### SUMMARY

### a) Technical Task

It is therefore the task according to the invention to provide a slicing machine, in particular a slicer, which can overcome these problems, in particular by enabling first cuts to be made from product calibers as appropriate in each case. It is also the task of the invention to provide a corresponding method.

### b) Solution of the Task

This task is solved by the features of claims 1 and 13. Advantageous embodiments result from the dependent claims.

A generic multi-track slicing machine, such as a slicer, for slicing at least one product caliber into slices and creating portions from the slices typically comprises
a cutting unit with a blade, in particular a rotatable blade, that is movable in a cutting plane, for cutting slices from the at least one product caliber,
a feed unit with a feed conveyor for feeding the product calibers to the cutting unit along a feed direction
and
a control unit for controlling moving parts of the slicing machine.

According to the invention, the slicing machine further comprises a measuring device which is in signal connection with the control unit and is adapted to measure at least one dimension of the product caliber in the height direction of the product caliber, in particular automatically.

Consequently, it is possible to use the dimension of the product caliber measured by the measuring device in the height direction to determine at which point on the end of the product caliber facing towards the cutting unit a first cut is to be made, i.e. an end piece of the product caliber is to be cut off, in order to ensure that the slices to be subsequently cut from this product caliber by the slicing machine have at least a predetermined height, for example in the case of a substantially circular product caliber at least a predetermined slice diameter, so that as far as possible no slices are cut which—possibly including their corresponding packaging—would have to be sorted out as rejects.

For example, while the product caliber is being moved in the feed direction by means of the feed conveyor, the measuring device can be used to monitor the dimension of the product caliber in the height direction at a suitable position in front of the cutting unit and the first cut can be made approximately, preferably exactly, at the point at which the product caliber has the predetermined dimension in the height direction. The measuring unit is preferably adapted to determine the dimension in the height direction at the cutting unit, in particular at a position of the blade arranged substantially in the cutting plane of the blade. Consequently, the blade can make the first cut as soon as the predetermined dimension of the product caliber in the height direction of the product caliber has been reached, preferably for the first time.

The measuring device can preferably also be adapted to measure a height profile of the product caliber over a length of the product caliber in the feed direction.

The measuring device can further be adapted to measure a dimension of the product caliber in the width direction of the product caliber. This can be advantageous particularly if the product caliber also has a dimension that varies over the length of the product caliber in the width direction of the product caliber, which differs significantly from the variation in the at least one dimension in the height direction of the product caliber.

It is also conceivable to make the first cut a few millimeters in the throughput direction, for example at most 50 mm, in particular at most 25 mm, preferably at most 10 mm or less, after a point of the product caliber at which the product caliber first has the predetermined dimension in the height direction, in particular starting from an end of the product caliber facing towards the cutting unit, in order to nevertheless maintain a certain buffer if the product caliber has, for example, varying dimensions over the circumference, i.e. is not symmetrical, and the dimension in the height direction is only measured at one point of the circumference, for example from above. In such a case, the predetermined dimension in the feed direction could, at least potentially, be reached earlier on a side of the product caliber facing towards the measuring device than on a side of the product caliber facing away from the measuring device.

According to a preferred exemplary embodiment, the control unit can be adapted to determine a first cut length of the product caliber in the throughput direction, preferably automatically, from the measured at least one dimension, in particular at least from a first dimension and a second dimension, in the height direction of the product caliber. Preferably, the first dimension can be smaller than the second dimension. Consequently, the control unit can, for example, use the at least one dimension, preferably automatically, to determine at which point, starting from a front end of the product caliber facing towards the cutting unit, the product caliber first has the at least one dimension of the product caliber in the height direction, and then control the cutting unit in such a way that a first cut is made at this point. If the control unit takes the first dimension and the second dimension of the product caliber into account, the first dimension can correspond to the front end of the product caliber facing towards the cutting unit and the second dimension can be a desired dimension in the height direction of the product caliber, which can, for example, correspond to a target slice height in the height direction.

In principle, the measuring device can be located at any suitable point on the slicing machine. Preferably, however, the measuring device is
arranged on an upper and/or a lower product guide of the slicing machine,
or
arranged adjacent to an upper and/or a lower product guide of the slicing machine.

In the first alternative embodiment mentioned above, it is conceivable that the measuring device is connected to the upper and/or lower product guide or is a component thereof. Thus, the control unit can be able, for example, to derive the dimension of the product caliber in the height direction from a position and/or a status of the upper and/or lower product guide.

In a further development of the first alternative embodiment, it is further conceivable that the measuring device is adapted to determine the dimension of the product caliber in the height direction from a pivot angle or a change in the pivot angle in particular of an end facing towards the cutting unit of the upper and/or lower product guide about a predetermined pivot axis. The predetermined pivot axis can be a substantially horizontal pivot axis. When using the slicing machine, the upper and/or lower product guide can first be pivoted about the predetermined pivot axis so that it is at a predetermined inclination angle to the feed direction of a respective product caliber. When the respective product caliber is then fed by the feed unit along the feed direction, the upper and/or lower product guide can realign itself substantially parallel to the feed direction as soon as the product caliber has at least the predetermined dimension in the height direction of the product caliber, for example at least a predetermined slice diameter. The first cut length can be determined by monitoring a feed distance of the product caliber in the feed direction which is traveled from a start time of a first change in the pivot angle to an end time at which the upper and/or lower product guide is aligned substantially parallel to the feed direction.

It is also possible to take only the change in the pivot angle into account, it being assumed, for example, that the product caliber has the predetermined dimension precisely when the pivot angle no longer changes as the product caliber continues to be fed in the feed direction. The first cut length can also be determined by monitoring a feed distance of the product caliber in the feed direction which is traveled from a start time of a first change in the pivot angle to an end time after which no further change in the pivot angle takes place as the product caliber continues to be fed in the feed direction.

In the two exemplary embodiments mentioned above, the feed distance can be monitored by the control unit of the slicing machine. Furthermore, an angle sensor which is in signal connection with the control unit can be fitted to the upper and/or lower product guide in order to determine the pivot angle.

Moreover, the measuring device may additionally or alternatively comprise a sensor, in particular a distance sensor such as a laser or similar, which is attached to the upper and/or lower product guide.

In the aforementioned second alternative embodiment, the measuring device can, for example, be arranged upstream, preferably directly upstream, of the upper and/or lower product guide with respect to the feed direction, i.e. it can be configured as a component separate from the respective product guide with a separate sensor, in particular a distance sensor such as a laser or similar. Consequently, in particular according to the second alternative embodiment, the upper and/or the lower product guide can, for example, be configured as a rigid product guide or does not necessarily have to be movable in the height direction of the product caliber or pivotable about an axis running substantially parallel to a width direction of the product caliber.

Furthermore, the measuring device can be configured as a contacting measuring device which is adapted to come into contact with the product caliber in order to be able to determine the at least one dimension of the product caliber in the height direction. In such a case, the measuring device can come into contact with the product caliber and, depending on this, determine at least the dimension of the product caliber in the height direction. Although appropriate installation space must be provided for the measuring device so as to be able to arrange it in the area of the movement path of the product caliber, a contacting measuring device usually has lower risk compared to a contactless, for example optical, measuring device whose measuring accuracy may be disturbed due to operational fouling or similar.

In a further development of this exemplary embodiment, the measuring device can preferably comprise a mechanical measured value recording unit, in particular a displacement measuring cylinder, and a caliber contact element, in particular a sensing rod, which is connected to the measured value recording unit, wherein the caliber contact element can be adapted to come into contact with the product caliber directly or indirectly. The measured value recording unit can thus be arranged away from the feed conveyor so that it does not interfere with the movement path of the product caliber, while only the caliber contact element should be able to come into contact with the product caliber directly or indirectly, for example via a sliding element or a rolling element such as a roller. The caliber contact element can be configured, for example, to be movable so as to follow the outer contour of the product caliber.

Further preferably, the caliber contact element, in particular the sensing rod, can be attached to the slicing machine, in particular to a frame, so as to be pivotable about a pivot axis. Consequently, by means of the mechanical measured value recording unit, from a pivot angle or a change in the pivot angle of the caliber contact element, for example, it is possible to draw conclusions about the dimension of the product caliber in the height direction by evaluating the pivot angle or the change in the pivot angle. “Mechanical” in this case means that a movement of the caliber contact element leads to a corresponding measurable movement on the mechanical measured value recording unit. The mechanical measured value recording unit, for example the displacement cylinder, can also comprise a sensor system arranged inside or outside the measured value recording unit whereby a movement and/or position of the mechanical measured value recording unit, for example a piston rod of the displacement cylinder, can be evaluated.

Particularly preferably, the caliber contact element, in particular the sensing rod, can have a first end, which is connected to the mechanical measured value recording unit, in particular the displacement measuring cylinder, and a second end opposite the first end, wherein the second end
can be adapted to come into contact with the product caliber,
or
can be connected, in particular rotatably, to an upper or lower product guide.

As a result, the caliber contact element can contact the product caliber directly or indirectly and follow the height profile, i.e. a respective height of the product caliber in the height direction of the product caliber. Alternatively, the second end can be connected to the upper or lower product guide so that a movement and/or position of the upper and/or lower product guide can be monitored by the control unit of the slicing machine and corresponding conclusions can be drawn about the height of the product caliber in the height direction.

According to a further exemplary embodiment, the measuring device can be configured as a contactless, in particular optical measuring device. It is also conceivable that the measuring device is configured as a combination of a contactless measuring device, as described below, and a contacting measuring device, as described above.

In principle, the contactless measuring device can work with any contactless measuring principle that is suitable for determining at least one dimension of the product caliber in the height direction. Preferably, the contactless measuring device can comprise a contactless, in particular optical, measured value recording unit, in particular a laser, which faces towards the feed conveyor, the contactless measured value recording unit preferably being adapted to determine a distance between the optical measured value recording unit and the product caliber.

Additionally or alternatively, it is also conceivable that the contactless measuring device comprises an, in particular optical, sensor unit which faces towards the upper and/or lower product guide and can be adapted to determine the pivot angle and/or the change in the pivot angle of the upper and/or lower product guide. The at least one dimension of the product caliber in the height direction can again be determined from the pivot angle and/or the change in the pivot angle in the same way as described above. In this context, the contactless measuring device is thus preferably arranged adjacent to the upper and/or lower product guide and is not part of the upper and/or lower product guide.

If the slicing machine is configured as a multi-track slicing machine with multiple tracks, the slicing machine can preferably comprise at least one measuring device described above for each of the multiple tracks.

It should be added that the feed unit can comprise a gripper carriage, which can carry one gripper for one product caliber per track, and a carriage guide along which the gripper carriage can be moved in a controlled manner in the feed direction.

Furthermore, the slicing machine can preferably comprise a discharge unit with a discharge conveyor, in particular a portioning belt, for the slices.

A generic method for slicing at least one product caliber into slices and for producing portions from the slices, in particular by means of a slicing machine, preferably a slicer according to the invention, comprises the following steps:
Feeding the at least one product caliber along a feed direction, in particular by means of a feed conveyor of a feed unit,
Cutting off slices from a front end of the at least one product caliber, in particular by means of a cutting unit,
Depositing the slices, in particular on a portioning belt, to create portions consisting of one or more slices.

According to the invention, before the slices are cut off from the front end of the at least one product caliber, at least one dimension of the product caliber is measured in the height direction of the product caliber, in particular by means of a measuring device.

It should be noted at this point that all the statements, advantages and effects described for the slicing machine according to the invention also apply to the method according to the invention and vice versa.

According to one exemplary embodiment, a first cut can be made a few millimeters in the throughput direction, for example at most 50 mm, in particular at most 25 mm, preferably at most 10 mm or less, after a point of the product caliber at which the product caliber first has the predetermined dimension in the height direction, in particular starting from an end of the product caliber facing towards the cutting unit.

Preferably, a first cut length of the product caliber in the throughput direction is determined, in particular by means of a control unit of the slicing machine, from the measured at least one dimension, in particular a measured first dimension and a measured second dimension, in the height direction of the product caliber. Preferably, the first dimension can be smaller than the second dimension.

The at least one dimension of the product caliber in the height direction of the product caliber can preferably be measured by contacting or contactless, in particular optical, means.

### BRIEF DESCRIPTION OF THE DRAWINGS

Embodiments according to the invention are described in more detail below by way of example. The following are shown:

FIGS. 1a, b: A known slicing machine in the form of a slicer according to the prior art in different perspective views, with the feed belt raised to the slicing position;

FIG. 2a: A simplified side view of the slicing machine according to the prior art, loaded with a product caliber, in a first functional position;

FIG. 2b: A side view as shown in FIG. 2a, but with the feed belt lowered to the loading position and with the product caliber sliced, except for a caliber end-piece;

FIG. 3a: A simplified partial side view of a slicing machine according to the invention, to which a measuring device according to a first exemplary embodiment is attached;

FIG. 3b: A simplified partial side view of a slicing machine according to the invention similar to FIG. 3a, to which a measuring device according to a second exemplary embodiment is attached; and

FIG. 3c: A simplified partial side view of a slicing machine according to the invention similar to FIG. 3b, to which a measuring device according to a third exemplary embodiment is attached.

### DETAILED DESCRIPTION

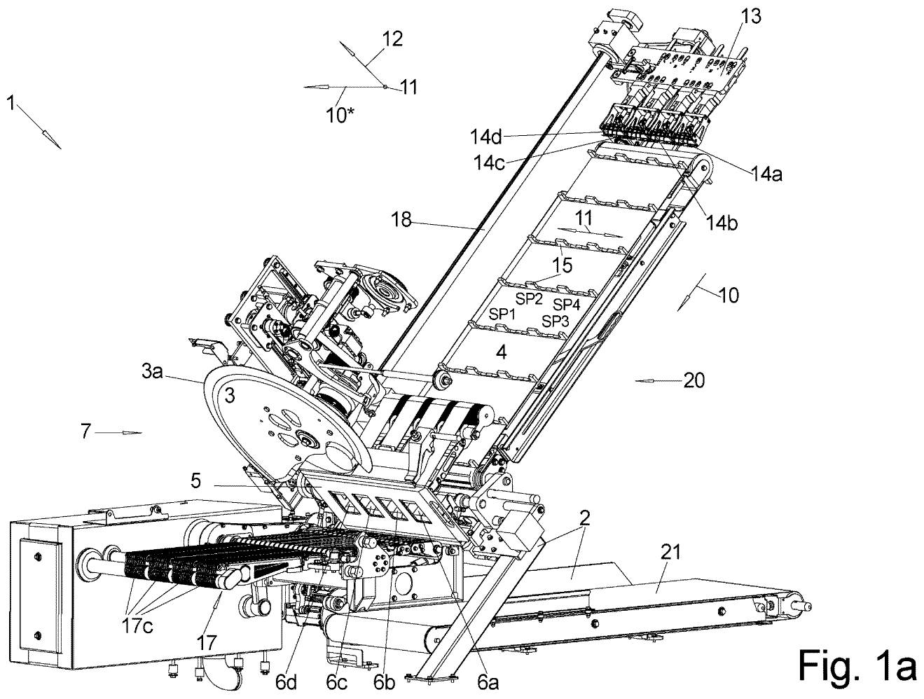

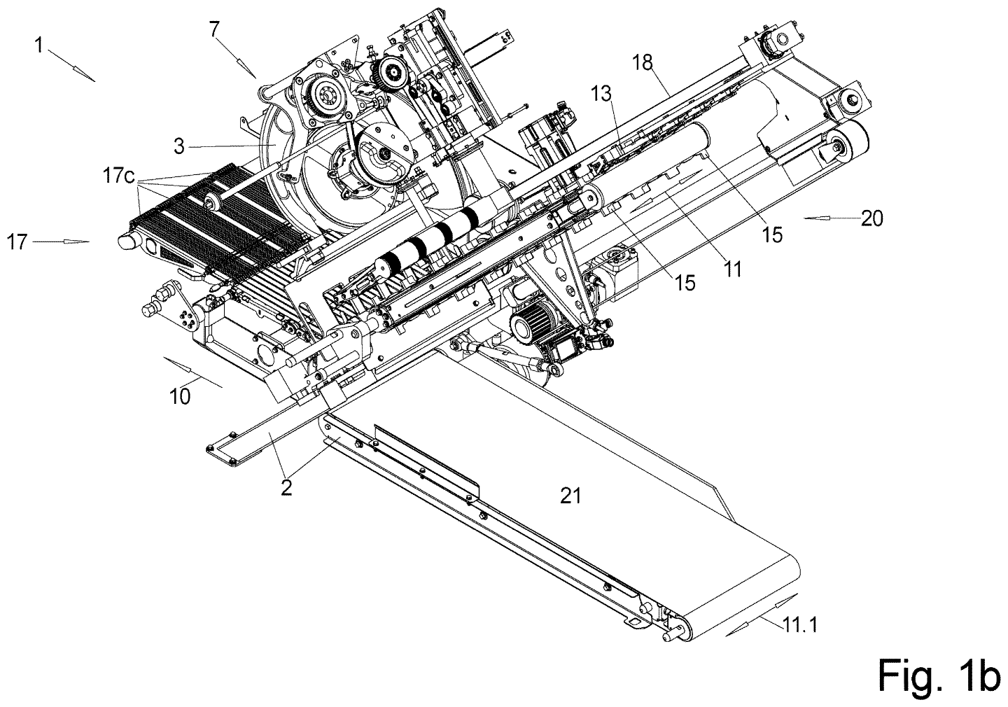

FIGS. 1a, 1b show different perspective views of a multi-track slicer 1 for the simultaneous slicing of multiple product calibers K—not shown for the sake of clarity—each on one track SP1 to SP4 lying adjacent to one another, and depositing them in shingled portions P each consisting of multiple slices S, with a general throughput direction 10* through the slicer 1 from right to left.

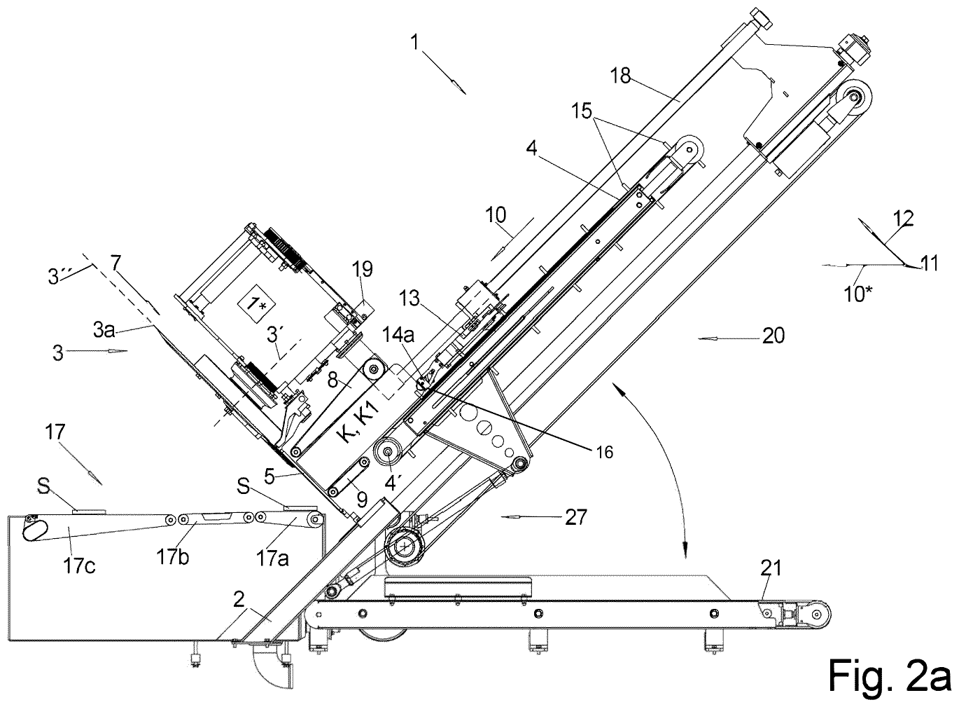

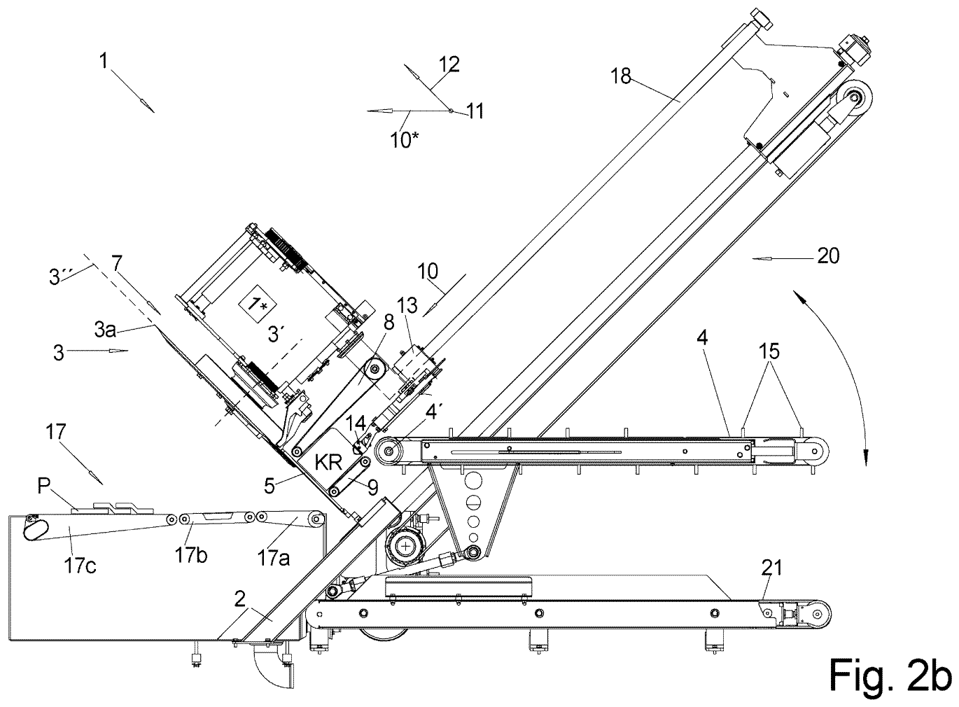

FIG. 2a and FIG. 2b show—with caliber K inserted—a side view of this slicer 1, omitting covers and other parts not relevant to the invention which like all other units are attached to the base frame 2, so that the functional parts, especially the conveyor belts, are more clearly visible. The longitudinal direction 10 is the feed direction of the caliber K to the cutting unit 7 and thus also the longitudinal direction of the caliber K lying in the slicer 1.

It can be seen that the basic structure of a slicer 1 according to the prior art consists in the fact that several, in this case four, product calibers K lying adjacent to one another on a feed conveyor 4 lying transversely to the feed direction 10 with spacers 15 of the feed conveyor 4 arranged between them are fed by this feed unit 20 to a cutting unit 7 with a blade 3, such as a sickle blade 3, rotating about an axis of rotation 3′, from whose front ends the rotating blade 3 cuts off a slice S with its cutting edge 3a in a single operation, i.e. almost simultaneously.

For slicing the product caliber K, the feed conveyor 4 is in the inclined slicing position shown in FIGS. 1a-2a, with the cutting-side front end lying low and the rear end lying high, from which it can be lowered about a pivot axis 4′ running in its width direction, the first transverse direction 11, located close to the cutting unit 7, to an approximately horizontal loading position, as shown in FIG. 2b.

According to FIG. 2a, the rear end of each caliber K lying in the feed unit 20 is held in a form-fitting manner by a gripper 14a-d with the aid of gripper claws 16. These grippers 14a-14d, which can be activated and deactivated with respect to the position of the gripper claws 16, are attached to a common gripper carriage 13 which can be moved along a gripper guide 18 in the feed direction 10. The gripper claws 16 are attached to the gripper 14 in a movable manner, i.e. they are movable between an engagement position and a release position.

The feed of both the gripper carriage 13 and the feed conveyor 4 can be driven in a controlled manner, but the actual feed speed of the calibers K is determined by so-called upper and lower driven product guides 8, 9, which are also driven in a controlled manner, in the form of circulating belts that engage the upper and lower sides of the caliber K to be sliced in their front end portions close to the cutting unit 7.

The front ends of the calibers K are each guided through a so-called product opening 6a-d of a plate-type cutting frame 5, the cutting plane 3″ in which the blade 3 rotates with its cutting edge 3a—and thus cuts off the end of the calibers K projecting from the cutting frame 5 as a slice S—running immediately in front of the front, downwardly inclined end face of the cutting frame 5. The cutting plane 3″ runs perpendicularly to the upper run of the feed conveyor 4 and/or is spanned by the two transverse directions 11, 12 to the feed direction 10.

The inner circumference of the product openings 6a-d serves as a counter-edge of the cutting edge 3a of the blade 3.

Since both product guides 8, 9 can be driven in a controlled manner, in particular independently of each other and/or possibly separately for each track SP1 to SP4, these determine the—continuous or timed—feed speed of the caliber K through the cutting frame 5.

The upper product guide 8 can be displaced in the second transverse direction 12—which runs perpendicularly to the surface of the upper run of the feed conveyor 4—in order to adapt to the height H of the caliber K in this direction. Furthermore, at least one of the product guides 8, 9 can be configured to be pivotable about one of its pulleys in order to be able to change, to a limited extent, the direction of the run of its guide belt in contact with the caliber K.

Below the feed unit 20 there is usually a roughly horizontal end-piece conveyor 21 which starts with its front end below the cutting frame 5 and immediately below or behind the discharge unit 17, and transports end-pieces falling onto it away towards the rear with its upper run, via the drive of one of the discharge conveyors 17 against the throughput direction 10*.

The slices S standing obliquely in the space while they are being cut fall onto a conveyor unit 17 which starts below the cutting frame 5 and runs in the throughput direction 10* and which in this case consists of a plurality of discharge conveyors 17a, b, c arranged with their upper runs approximately in alignment one after the other in the throughput direction 10*, of which the first conveyor 17a in the throughput direction 10* can be configured as a portioning belt 17a and/or of which one can also be configured as a weighing unit.

The slices S can arrive on the discharge unit 17 individually and spaced apart from one another in the general throughput direction 10* of the products through the machine or, by appropriate control of the portioning belt 17a of the discharge unit 17—whose movement, like almost all moving parts, is controlled by the control unit 1*—can form shingled or stacked portions P through stepwise forward movement of the portioning belt 17a.

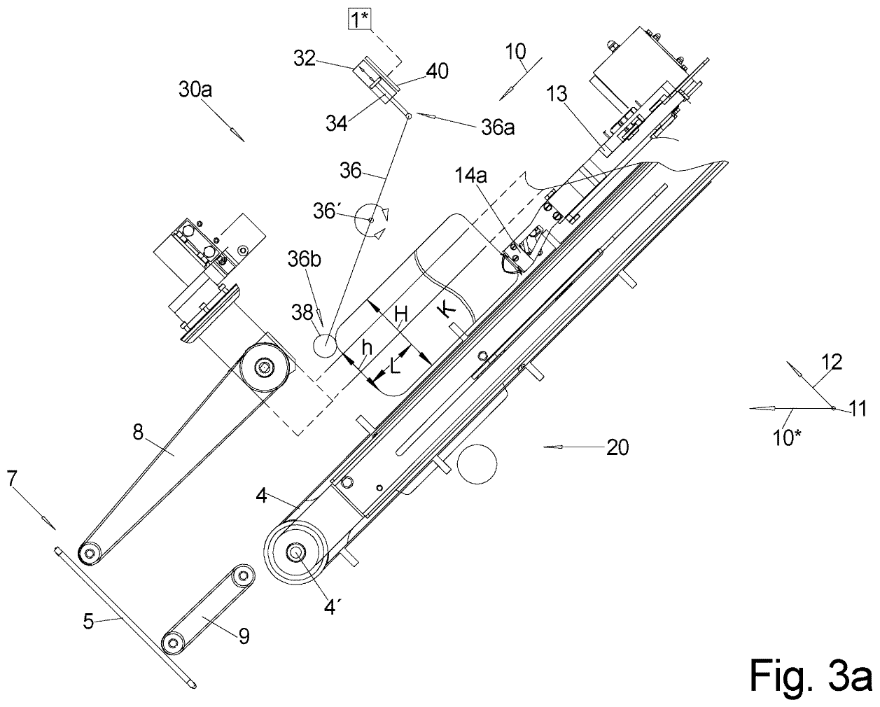

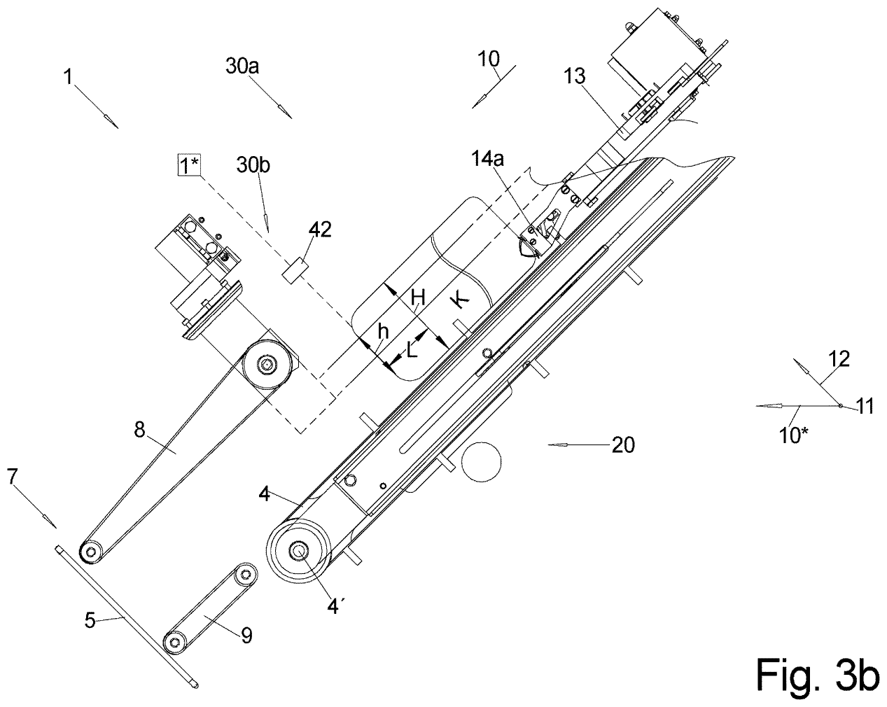

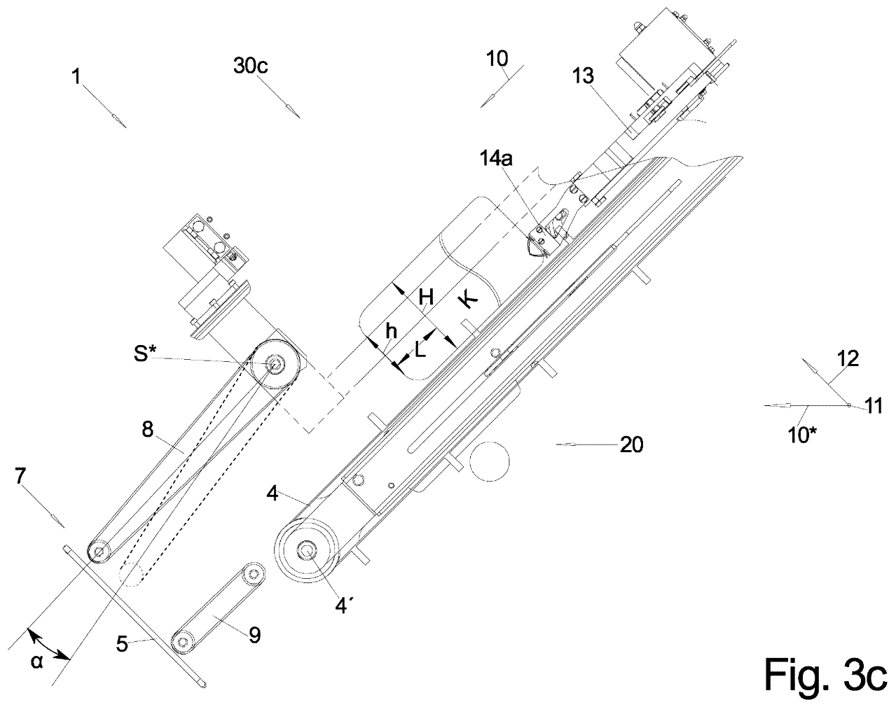

FIG. 3a is a simplified partial side view of a slicing machine 1 according to the invention, to which a measuring device 30a according to a first exemplary embodiment is attached. It should be noted at this point that the slicing machine 1 according to the invention will only be described in detail with regard to features which differ from the slicing machine according to the prior art described above, reference being made to the above explanations regarding the generally known features and functions of the slicing machine according to the invention.

As can be seen in FIG. 3a, a product caliber K can have a taper at least at its front end in the feed direction 10, i.e. at its end facing towards the cutting frame 5, which can result in the product caliber K having a first dimension h in the height direction 12 of the product caliber K at the front end which is smaller than a second dimension H in the height direction 12 of the product caliber K in a region between the front end and a rear end of the product caliber K opposite the front end. This can lead to at least some of the first slices S, which are cut from the product caliber K, only having a slice height that corresponds to the first dimension h, or is slightly larger but smaller than the desired second dimension H, which can be a target slice height in the height direction 12, for example. Consequently, before the slices S are cut, it is first necessary to make a first cut, i.e. an end piece of the product caliber K must be cut off from the end of the product caliber K facing towards the cutting frame 5, in order to ensure that the slices S subsequently sliced from this product caliber K by the slicing machine 1 have at least the second dimension H, which corresponds to a predetermined dimension H in the height direction 12, i.e. a predetermined slice height.

To overcome this problem, the slicing machine 1 according to the invention is provided with the measuring device 30a which is in signal connection with the control unit 1* and is adapted to measure at least the dimensions h, H of the product caliber K in the height direction 12 of the product caliber K. As a result, it is possible to use the dimensions h, H of the product caliber K measured by the measuring device 30a in the height direction 12 to determine at which point on the end of the product caliber K facing towards the cutting frame 5 the first cut is to be made, i.e. the end piece is to be cut off.

For this purpose, the measuring device 30a, which in the example shown is arranged upstream of the upper product guide 8 of the slicing machine 1, can comprise a mechanical measured value recording unit 32, for example in the form of a displacement measuring cylinder 32, as shown in FIG. 3a, and a caliber contact element 36, which in the present case is configured as a sensing rod 36. The sensing rod 36 is connected to the measured value recording unit 32 and is adapted to come into contact with the product caliber K indirectly via a sliding element or a rolling element, such as a roller 38, which slides or rolls along the product caliber K. The measuring device 30a in FIG. 3a is therefore configured as a contacting measuring device, which is adapted to come into contact with the product caliber K.

Furthermore, the sensing rod 36 can have a first end 36a, which is connected to the displacement measuring cylinder 32, and a second end 36b opposite the first end 36a, the second end 36b being arranged so as to come into contact with the product caliber K.

According to an alternative exemplary embodiment, not shown, the second end 36b can instead be connected to the upper product guide 8 or the lower product guide 9, so that a movement, such as a pivoting movement and/or a translatory movement, or a position of the product guide 8 and/or 9 can be monitored by means of the control unit 1* of the slicing machine 1 and corresponding conclusions can be drawn about the dimensions h, H of the product caliber K in the height direction 12.

Since the sensing rod 36 can be mounted on the slicing machine 1 so as to be pivotable about a pivot axis 36′, in particular on a frame of the slicing machine 1 not shown in FIG. 3a, contact of the sensing rod 36 leads to a corresponding pivoting movement of the sensing rod 36 about the pivot axis 36′, which in turn can cause a corresponding deflection of a piston rod 34 of the displacement measuring cylinder 32 in or against the height direction 12. The deflection of the piston rod 34 can be monitored by means of a displacement and/or position sensor 40, which can be in signal connection with the control unit 1* of the slicing machine 1. From the deflection of the piston rod 34, the control unit 1* can determine the dimensions h, H of the product caliber K accordingly and from this determine at which point in the feed direction 10 a first cut is to be made on the product caliber K.

In the present exemplary embodiment, the signals received from the measuring device 30a are used to determine a first cut length L, which can correspond to a length in the feed direction 10 between the front end of the product caliber K facing towards the cutting frame 5 and a point of the product caliber K at which the product caliber K first reaches the dimension H. In other words, the first cut length L can correspond to the distance between the dimensions h and H of the product caliber K shown in FIG. 3a, the first cut length L in FIG. 3a being deliberately drawn somewhat longer than necessary for the sake of clarity. The point at which the product caliber K first reaches the second dimension H can lie in a first cut plane along which the blade 3 makes the first cut as soon as the product caliber K has been further advanced by a corresponding amount in the feed direction 10, so that the product caliber K protrudes in the feed direction 10 by approximately the first cut length L beyond the cutting frame 5 or the cutting plane 3″ of the blade 3, in particular its cutting edge 3a. For this purpose, a sensor (not shown in FIG. 3a), for example an optical sensor or similar, can be provided in the area of the cutting frame 5, which can be in signal connection with the control unit 1* and can be adapted to detect when the product caliber K reaches the cutting frame 5, so that it can then be further advanced by the feed conveyor 4 and/or the upper product guide 8 and/or the lower product guide 9 by the first cut length L in the feed direction 10 before the first cut is made.

Furthermore, the slicing machine 1 can be adapted to make the first cut in the throughput direction several millimeters, for example at most 50 mm, in particular at most 25 mm, preferably at most 10 mm or less, after the point of the product caliber K at which the product caliber K first reaches the dimension H in the height direction 12.

FIG. 3b is a simplified partial side view of a slicing machine 1 according to the invention, to which a measuring device 30b according to a second exemplary embodiment is attached.

The measuring device 30b can preferably be configured as a contactless, in particular optical, measuring device 30b. In particular, it is also conceivable that the measuring device is configured as a combination of a contactless measuring device 30b described below and a contacting measuring device 30a as described above in order to further optimize the measuring accuracy of the measuring device and thus the operation of the slicing machine 1.

The contactless measuring device 30b can comprise a contactless, in particular optical, measured value recording unit 42, which in the illustrated exemplary embodiment is configured as a laser 42 facing towards the feed conveyor 4. The laser 42 can be configured to determine a distance between the laser 42 and the product caliber K. From this, the control unit 1* can determine the first dimension h or the second dimension H of the product caliber K in the height direction 12, i.e. how high the product caliber K is in the height direction 12, if, for example, the distance between the laser 42 and a support surface of the feed conveyor 4 has previously been determined or is known.

When using the contactless measuring device 30b, it is also possible to determine the first cut length L in that the control unit 1* detects, by means of the measuring device 30b, when the front end of the product caliber K is first detected by the laser 42, and detecting on this basis by what amount the product caliber K must be advanced in the feed direction 10, starting from the first detection of the front end, until the product caliber K has at least the predetermined dimension H in the height direction 12, which can be substantially constant.

As shown in FIG. 3c, according to a further exemplary embodiment it is conceivable that the measuring device 30c is adapted to determine the dimension of the product caliber K in the height direction 12 and thus the required first cut length L from a pivot angle α or a change in the pivot angle α, in particular of an end of the upper product guide 8 facing towards the cutting unit 1 about a predetermined pivot axis S *. In the example shown in FIG. 3c, the predetermined pivot axis S* runs substantially in a horizontal direction.

When using the slicing machine 1, the upper product guide 8 can first be pivoted about the predetermined pivot axis S* starting from a position in which the upper product guide 8 is aligned substantially parallel to the feed direction 10, so that it is at the predetermined inclination angle α to the feed direction 10 of the product caliber K. The pivoted position of the upper product guide 8 is only shown schematically with dashed lines in FIG. 3c.

When the respective product caliber K is then fed by the feed unit 20 along the feed direction 10 and the product caliber K begins to be in contact with the upper product guide 8, the pivot angle α changes until the upper product guide 8 is preferably aligned substantially parallel to the feed direction 10 again. The first cut length L can be determined by monitoring a feed distance of the product caliber K in the feed direction 10 which is traveled from a start time of a first change in the pivot angle α to an end time at which the upper product guide 8 is aligned substantially parallel to the feed direction 10.

It is also possible to take only the change in the pivot angle α into account, it being assumed, for example, that the product caliber K has the predetermined dimension H precisely when the pivot angle α no longer changes as the product caliber K continues to be fed in the feed direction 10. The first cut length L can also be determined by monitoring a feed distance of the product caliber K in the feed direction 10 which is traveled from a start time of a first change in the pivot angle α to an end time after which no further change in the pivot angle α takes place as the product caliber K continues to be fed in the feed direction 10.

The feed distance can be monitored by the control unit 1* of the slicing machine 1. Furthermore, to determine the pivot angle α, the measuring device 30c can comprise an angle sensor (not shown) which is attached to the upper product guide 8 and can be in signal connection with the control unit 1 *.

It should be added that the slicing machine 1 can comprise at least one measuring device 30a and/or 30b and/or 30c described above for each of the plurality of tracks SP1-SP4, in order to determine the dimensions h, H for each individual track for each product caliber K and to be able to make a corresponding first cut, preferably with a track-specific first cut length L, in each case.

### LIST OF REFERENCE NUMBERS

1 Slicing machine, slicer
1* Control unit
2 Base frame
3 Blade
3′ Axis of rotation
3″ Blade plane, cutting plane
3a Cutting edge
4 Feed conveyor, feed belt
4′ Pivot axis
5 Cutting frame
6a-d Frame opening
7 Cutting unit
8 Upper product guide, upper guide belt
9 Lower product guide, lower guide belt
10 Feed direction
10* Throughput direction through machine
11 1. Transverse direction (across width of slicer)
12 2. Transverse direction (in height direction of caliber)
12* Vertical
13 Gripper unit, gripper carriage
13.1 Projection
13.2 Mounting section
13.2 Projection
13.4 Mounting section
14, 14 a-d Gripper
15 Spacer
15′ Support surface
15″ Feed plane
16 Gripper claw
17 Discharge unit
17a, b, c Portioning belt, discharge conveyor
18 Gripper guide
20 Feed unit
21 End-piece conveyor
22 End-piece ejector
23 Scraper
30a, b, c Measuring device
32 Mechanical measured value recording unit, displacement measuring cylinder
34 Piston rod
36 Caliber contact element, piston rod
36a First end
36b Second end
36′ Pivot axis
38 Sliding element, rolling element, roller
40 Displacement and/or position sensor
42 Contactless measured value recording unit, laser
S Slice
S* Pivot axis
P Portion
h First dimension in height direction
H Second dimension in height direction
α Pivot angle

1. A slicing machine, in particular slicer, for slicing at least one product caliber into slices and for producing portions from the slices, with
a cutting unit with a blade, in particular a rotatable blade that is movable in a cutting plane, for cutting slices from the at least one product caliber
a feed unit with a feed conveyor for feeding the product calibersto the cutting unit along a feed direction and
a control unit for controlling moving parts of the slicing machine. wherein
the slicing machine further comprises a measuring device which is in signal connection with the control unit and is adapted to measure at least one dimension of the product caliber in the height direction of the product caliber.

2. The slicing machine according to claim 1, wherein
the slicing machineis adapted to make a first cut a few millimeters in the throughput direction, for example at most 50 mm, in particular at most 25 mm, preferably at most 10 mm or less, after a point of the product caliber at which the product caliber first has the predetermined dimension, in the height direction, in particular starting from an end of the product caliber facing towards the cutting unit.

3. The slicing machine according to claim 1, wherein
the control unit is adapted to determine a first cut length of the product caliber in the throughput direction from the measured at least one dimension, in particular a measured first dimension and a
measured second dimension, in the height direction of the product caliber
the first dimension preferably being smaller than the second dimension.

4. The slicing machine according to claim 1, wherein
the measuring device
is arranged on an upper and/or a lower product guide of the slicing machine,
or
is arranged adjacent to an upper and/or a lower product guide of the slicing machine.

5. The slicing machine according to claim 4, wherein oferized
the measuring device is adapted to determine the at least one dimension of the product caliber in the height direction from a pivot angle or a change in a pivot angle in particular of an end facing towards the cutting unit of the upperand/or lower product guide about a predetermined pivot axis.

6. The slicing machine according to any-preceding claim 1, wherein
the measuring deviceis configured as a contacting measuring device which is adapted to come into contact with the product caliber.

7. The slicing machine according to claim 6, wherein
the measuring device preferably comprises a mechanical measured value recording unit, in particular a displacement measuring cylinder, and a caliber contact element, in particular a sensing rod, which is connected to the measured value recording unit, wherein the caliber contact element, can be adapted to come into contact with the product caliber directly or indirectly.

8. The slicing machine (according to claim 7, wherein
the caliber contact element, in particular the sensing rod, is attached to the slicing machine, in particular to a frame, so as to be pivotable about a pivot axis.

9. The slicing machine (according to claim 8, wherein
the caliber contact element, in particular the sensing rod, can have a first end which is connected to the mechanical measured value recording unit, in particular the displacement measuring cylinder, and a second end opposite the first end,
wherein the second end is adapted to come into contact with the product caliber or is connected to an upper or a lower product guide.

10. The slicing machine according claim 1,
wherein the measuring device can be configured as a contactless, in particular optical, measuring device.
in particular the measuring device is configured as a combination of a contactless and a contacting measuring device.

11. The slicing machine, according to claim 10,
wherein the contactless measuring device comprises a contactless, in particular optical, measured value recording unit, in particular a laser, which faces towards the feed conveyor,
wherein the contactless measured value recording unit is preferably adapted to determine a distance between the optical measured value recording unit and the product caliber K.

12. SlicingThe slicing machine according to claim 1, wherein
the slicing machine is configured as a multi-track slicing machine with multiple tracks
the slicing machine comprises at least one measuring device-for each of the plurality of tracks.

13. A method for slicing at least one product caliber into slices and for producing portions from the slices, in particular by means of a slicing machine preferably a slicer, in particular according to any of the preceding claims, the method comprising the following steps:
Feeding of the at least one product caliber along a feed direction, in particular by means of a feed conveyor(of a feed unit,
Cutting off slices from a front end of the at least one product caliber, in particular by means of a cutting unit,
Depositing the slices, in particular on a portioning belt, to create portions consisting of one or more slices
wherein before the slices are cut off from the front end of the at least one product caliber, at least one dimension of the product caliber is measured in the height direction of the product caliber, in particular by means of a measuring device.

14. The method according to claim 13, wherein
before the slices are cut off from the front end of the at least one product caliber, a first cut can be made a few millimeters in the throughput direction, for example at most 50 mm, in particular at most 25 mm, preferably at most 10 mm or less, after a point of the product caliber at which the product caliber first has the predetermined dimension in the height direction, in particular starting from an end of the product caliber facing towards the cutting unit.

15. The method according to claim 13, wherein
a first cut length of the product caliber in the throughput direction is determined, in particular by means of a control unit of the slicing machine, from the measured at least one dimension, in particular a measured first dimensionand a measured second dimension, in the height direction,
the first dimension preferably being smaller than the second dimension.

16. The method according to any of claims 13, wherein
at least one dimension of the product caliber is measured in the height direction of the product caliber by contacting or contactless means, in particular optically.
